(19) United States
(12) Patent Application Publication
(10) Pub. No.: US 2016/0070317 A1
(43) Pub. Date: Mar. 10, 2016

(54) MOUNTING SYSTEM FOR HARD DISK DRIVE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: YONG-CHANG FAN, Wuhan (CN)

(21) Appl. No.: 14/528,432

(22) Filed: Oct. 30, 2014

(30) Foreign Application Priority Data
Sep. 5, 2014 (CN) 201410450901.0

(51) Int. Cl. G06F 1/18; B65D 25/10

(52) U.S. Cl. CPC G06F 1/187; G06F 1/181; B65D 25/10

(57) ABSTRACT

A mounting system includes a case, a holding plate, and two resilient members. The case includes a bottom plate and two side plates extending from the bottom plate. The holding plate is mounted in the case above the bottom plate and configured to hold the hard disk drive. Each resilient member has a first end secured to the case and a second end secured to the holding plate. Each side plate defines a latching slot. The holding plate is movable relative to the case to elastically deform the resilient members, and the latching slot is configured for a mounting post located on the hard disk drive to move along when the holding plate is moved.

### FIELD

The subject matter herein generally relates to a mounting system for a hard disk drive and an electronic device with the mounting system.

### BACKGROUND

An electronic device with a hard disk drive generally includes a mounting system for the hard disk drive. The mounting system generally includes a case configured for receiving the hard disk drive.

### BRIEF DESCRIPTION OF THE DRAWINGS

Implementations of the present technology will now be described, by way of example only, with reference to the attached figures.

FIG. 1 is an exploded, isometric view of an embodiment of an electronic device with a mounting system and a hard disk drive.

FIG. 2 is an assembled, isometric view of the mounting system and the hard disk drive of FIG. 1.

FIG. 3 is a diagrammatic view of the electronic device with the mounting system and the hard disk drive of FIG. 2, showing the electronic device in a first state.

FIG. 4 is similar to the FIG. 3, but showing the electronic device in a second state.

FIG. 5 is similar to the FIG. 3, but showing the electronic device in a third state.

FIG. 6 is similar to the FIG. 3, but showing the electronic device in a fourth state.

FIG. 7 is similar to the FIG. 3, but showing the electronic device in a fifth state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

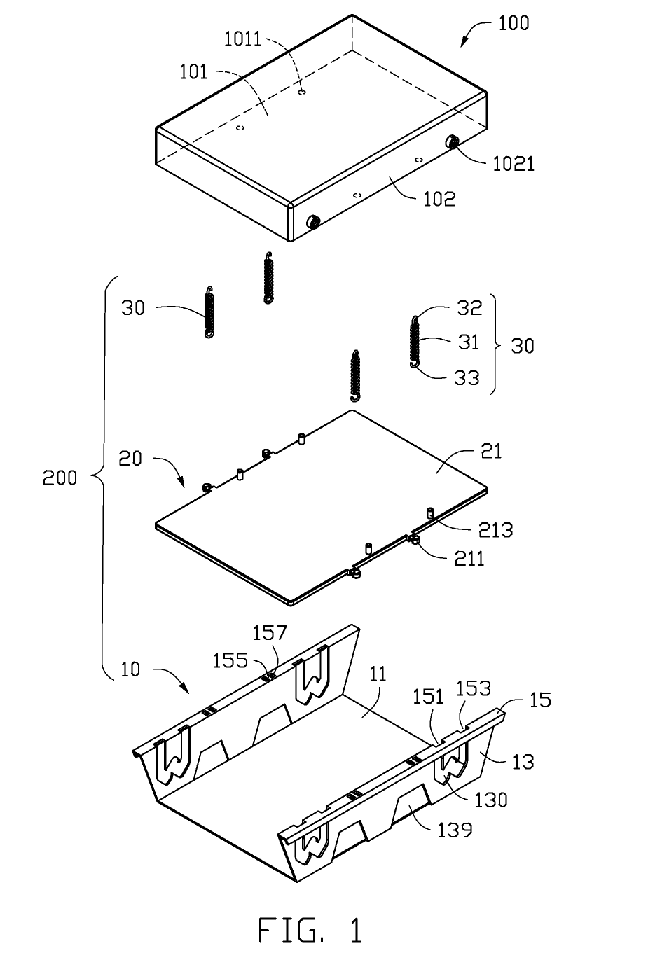

FIG. 1 illustrates an electronic device including a mounting system 200 and a hard disk drive 100 in accordance with an embodiment.

The hard disk drive 100 can include a bottom wall 101 and two sidewalls 102. The bottom wall 101 defines a plurality of positioning holes 1011. Two mounting posts 1021 extend outwards from each sidewall 102. In at least one embodiment, the mounting posts 1021 can be fasteners secured to the sidewalls 102.

The mounting system 200 can include a case 10 configured for securing the hard disk drive 100, holding plate 20, and at least one resilient member 30.

The case 10 can include a bottom plate 11 and two side plates 13 extending from opposite edges of the bottom plate 11. A blocking plate 15 extends outwards from a top edge of each side plate 13.

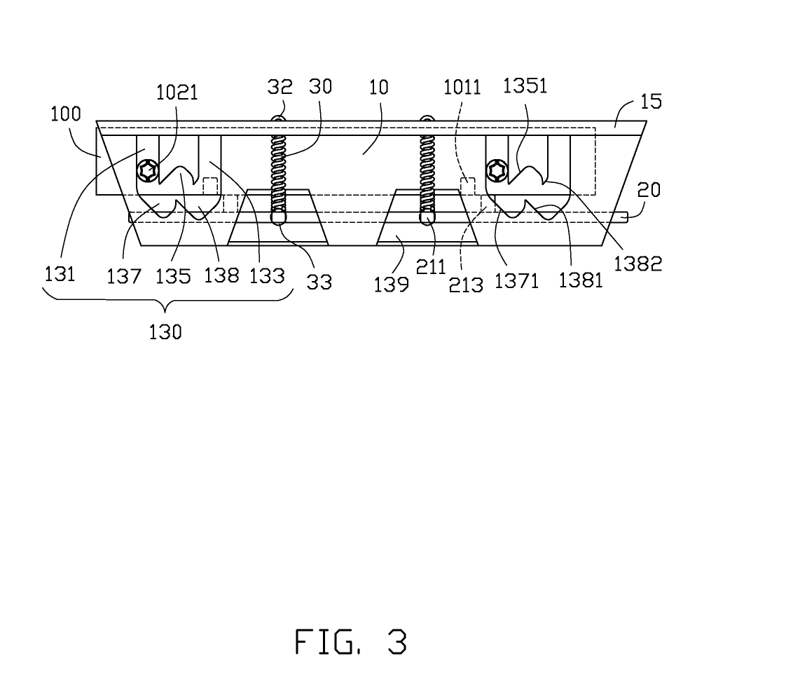

FIGS. 1 and 3 illustrate that each side plate 13 defines at least a latching slot 130. The latching slot 130 is substantially “W” shaped. The latching slot 130 can include a slide-in slot 131, a slide-out 133, and a latching slot 135. In at least one embodiment, the slide-in slot 131 is substantially perpendicular to the bottom plate 11, and the slide-out slot 133 is substantially parallel to the slide-in slot 131. A first end of the slide-in slot 131 extends to the blocking plate 15 to form an entrance 151. A first sliding slot 137 extends slantingly from a second end of the slide-in slot 131. A first end of the slide-out slot 133 extends to the export 153. A second sliding slot 138 extends slantingly from a second end of the slide-out slot 133. The first sliding slot 137 is communicated with the second sliding slot 138 via the latching portion 135. The latching slot 130 extends out of the side plate 13.

The latching portion 135 is substantially inverted “V” shaped and includes a slant plane 1351. The slant plane 1351 is configured to guide the mounting post 1021 to slide into the latching portion 135.

The first sliding slot 137 can include a guide-in plane 1371. An obtuse angle is defined between the guide-in plane 1371 and an extending direction of the slide-in slot 131. The second sliding slot 138 can include a first guide-out plane 1381 and a second guide-out plane 1382. In at least one embodiment, the first guide-out plane 1381 is substantially parallel to the guide-in plane 1371, and the second guide-out plane 1382 is a sidewall of the second sliding slot 138.

Each side plate 13 further defines two receiving portions 139 extending through the side plate 13. In at least one embodiment, each receiving portion 139 is trapezoidal. A mounting piece 155 is located on the blocking plate 15 to secure the resilient member 30. The blocking plate 15 defines two openings 157 located on opposite sides of the mounting piece 155.

The holding plate 20 can include a plate body 21, two mounting blocks 211 extending outwards from opposite side edges of the plate body 21, and a plurality of positioning posts 213 extending upwards from a top surface of the plate body 21. In at least one embodiment, each mounting post 211 is substantially I-shaped.

The resilient member 30 can include a resilient portion 31, a first ear portion 32, and a second ear portion 33. In at least one embodiment, the resilient member 30 is an extension spring.

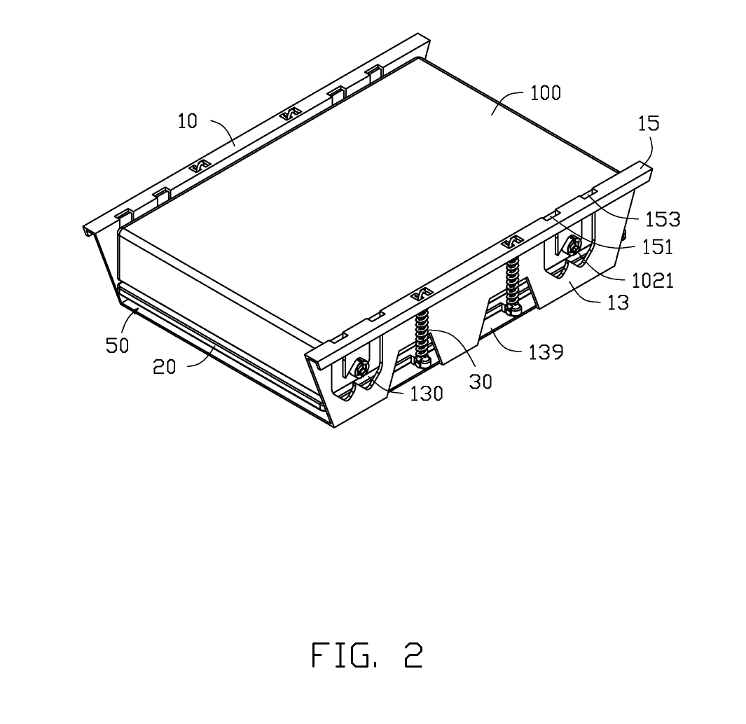

FIG. 2 illustrates that during assembly, the holding plate 20 is moved into the case 10 in a direction substantially perpendicular to the bottom plate 11. The mounting blocks 211 press the side plates 13 to elastically deform the two side plates 13 outwards. When the mounting blocks 211 extend out of the receiving portions 139, the side plates 13 rebound. The first ear portion 32 is latched to the mounting piece 155 through the opening 157. The second ear portion 33 is engaged with the mounting block 211. A gap 50 is defined between the holding plate 20 and the bottom plate 11. The resilient member 30 is located outside of the side plate 13 in an initial state. In at least one embodiment, the resilient member 30 is substantially perpendicular to the bottom plate 11, and the holding plate 20 is substantially parallel to the bottom plate 11. Thus, the mounting system 200 is completely assembled.

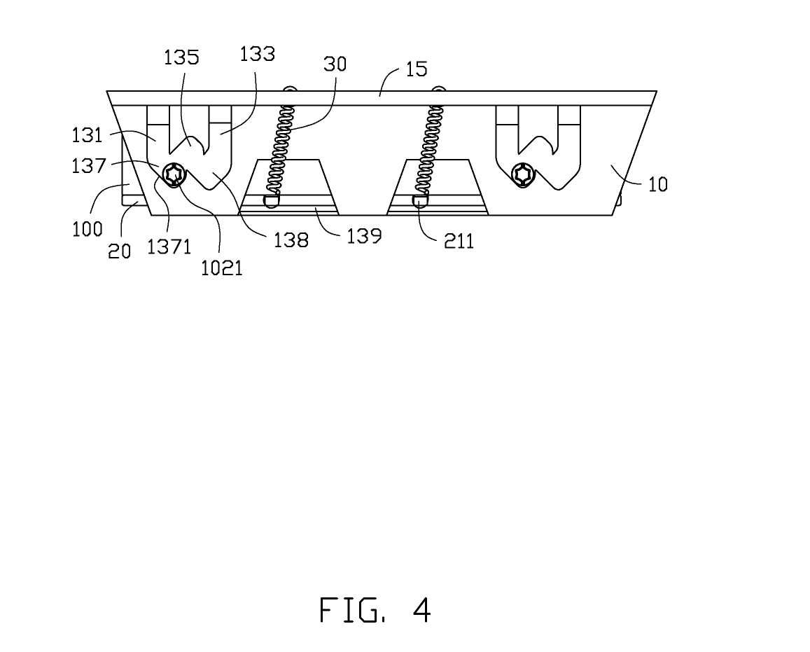

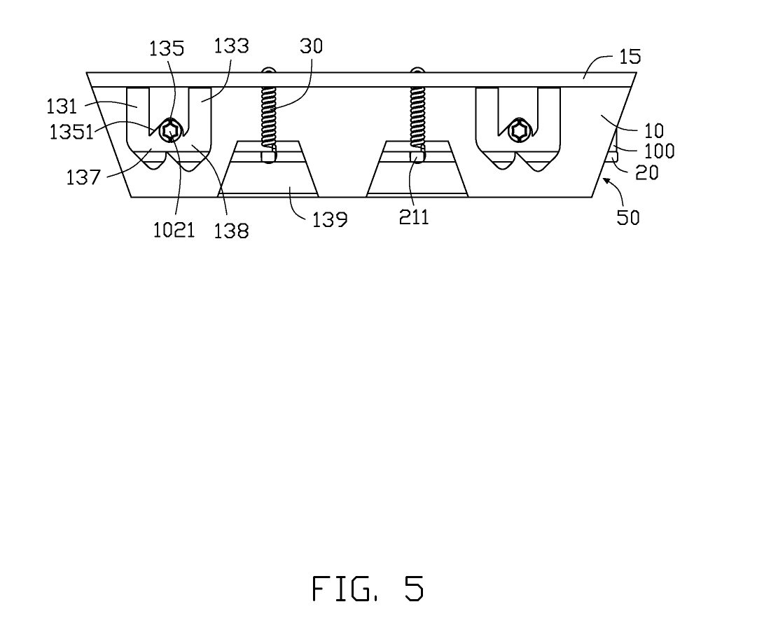

FIG. 4 illustrates that in assemble of the hard disk drive 100 to the mounting system 200, the mounting posts 1021 slide into the slide-in slot 131 via the entrance 151, the holding plate 20 is adjusted to engage the positioning posts 213 in the positioning holes 1011. The hard disk drive 100 is pressed downwards to move the holding plate 20 towards the bottom plate 11, the resilient member 30 is elastically deformed, and the mounting post 1021 is slid in the slide-in slot 131 and the first sliding slot 137. When the mounting post 1021 is slid in the first sliding slot 137, the resilient member 30 is slant relative to the bottom plate 11. When the mounting post 1021 is blocked by an end of the first sliding slot 137, the hard disk drive 100 is released, the resilient member 30 rebounds upwards to move the hard disk drive 100 and the holding plate 20 away from the bottom plate 11 until the mounting post 1021 is engaged with the latching portion 135 (shown as in FIG. 5).

FIG. 5 illustrates that when the mounting post 1021 is engaged with the latching portion 135, the resilient member 30 is substantially perpendicular to the bottom plate 11. When the hard disk drive 100 is shocked, the resilient member 30 is elastically deformed to move the holding plate 20 up and down to protect the hard disk drive 100.

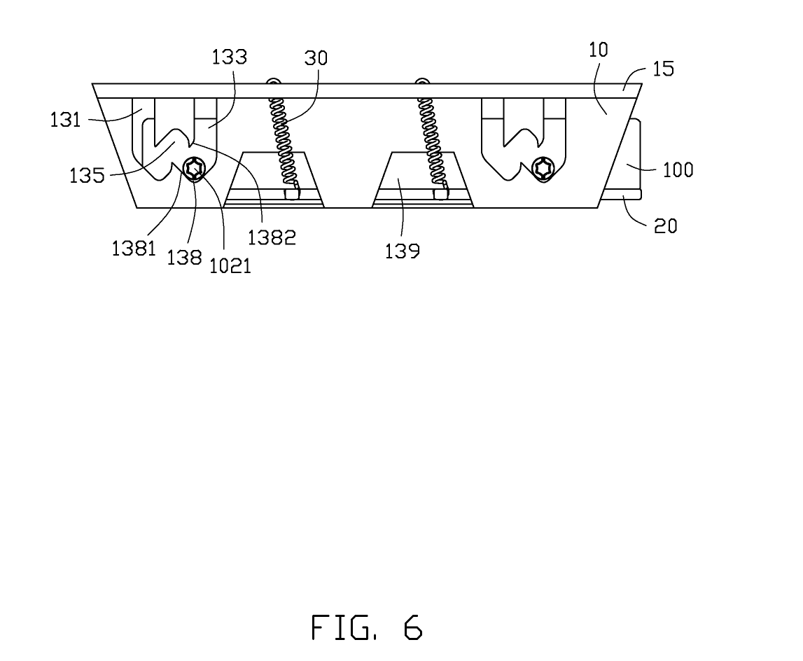

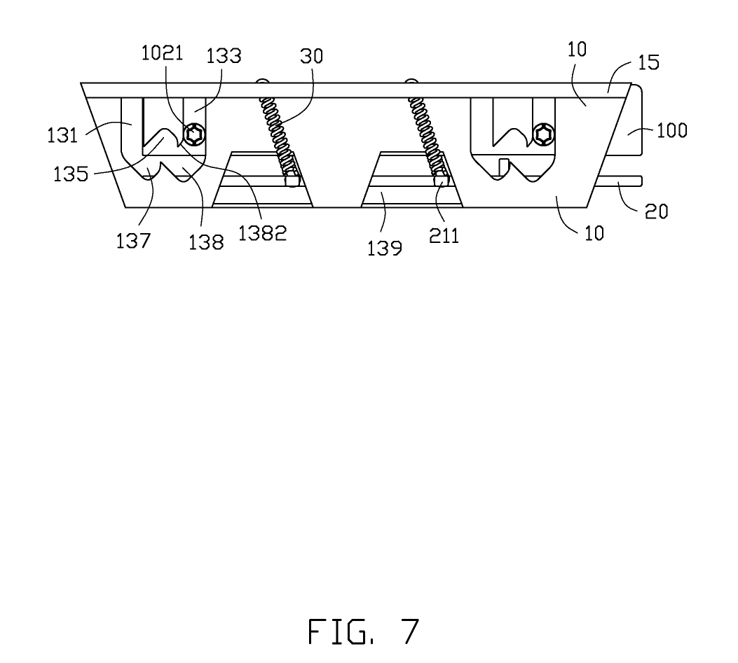

FIGS. 6 and 7 illustrate that in disassembly of the hard disk drive 100, the hard disk drive 100 is pressed downwards to move the holding plate 20 towards the bottom plate 11, the resilient member 30 is elastically deformed, and the mounting post 1021 is slid in the second sliding slot 138 from the latching portion 135. When the mounting post 1021 is slid in the second sliding slot 138, the resilient member 30 is slant relative to the bottom plate 11. When the mounting post 1021 is blocked by an end of the second sliding slot 138, the hard disk drive 100 is released, the resilient member 30 rebounds upwards to move the hard disk drive 100 and the holding plate 20 away from the bottom plate 11. The hard disk drive 100 is moved upwards relative to the holding plate 20, the mounting post 1021 is moved out of the export 153 via the slide-out slot 133, and then the hard disk drive 100 can be removed from the holding plate 20 and the case 10.

The embodiments shown and described above are only examples. Many details are often found in the art such as the other features of a mounting system for hard disk drive. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A mounting system for a hard disk drive comprising:
a case comprising a bottom plate and two side plates extending from the bottom plate;
a holding plate mounted in the case above the bottom plate and configured to hold the hard disk drive; and
two resilient members, and each resilient member having a first end secured to the case and a second end secured to the holding plate;
wherein each side plate defines a latching slot, the holding plate is movable relative to the case to elastically deform the resilient members, and the latching slot is configured for a mounting post located on the hard disk drive to move along when the holding plate is moved.

2. The mounting system of claim 1, wherein the holding plate comprises two mounting portions, and the second ends of the resilient members are secured to the mounting portions; each side plate defines a receiving portion, and each mounting portion extends out of the case through the receiving portion.

3. The mounting system of claim 2, wherein the case further comprises a blocking plate extending outwards from a top edge of each side plate and a blocking piece located on the blocking plate, and the first end of each resilient member is secured to the blocking piece.

4. The mounting system of claim 3, wherein the latching slot is substantially “W” shaped.

5. The mounting system of claim 3, wherein the latching slot comprises a slide-in slot, a slide-out slot, and a latching portion between the slide-in slot and the slide-out lot, the slide-in slot is configured for the mounting post to slide in, the slide-out slot is configured for the mounting post to slide out of the latching slot, and the latching portion is configured to block the mounting post in the latching slot.

6. The mounting system of claim 5, wherein the slide-in slot is substantially parallel to the slide-out slot.

7. The mounting system of claim 5, wherein the latching portion is substantially inverted “V” shaped.

8. The mounting system of claim 5, wherein the latching slot further comprises a first sliding slot extending slantingly from the slide-in slot and a second sliding slot extending slantingly from the slide-out slot, the slide-in slot is communicated with the slide-out slot via the latching portion, and the latching portion is above the first sliding slot and the second sliding slot.

9. The mounting system of claim 2, wherein the holding plate further comprises a plate body and a plurality of positioning posts extending from the plate body, the mounting portions extend from the plate body, and the positioning posts are configured to engage in a plurality of positioning holes defined in the hard disk drive.

10. The mounting system of claim 1, wherein the holding plate is substantially parallel to the bottom plate.

11. A mounting system for a hard disk drive comprising:
a case comprising a bottom plate and two side plates extending from the bottom plate;
a holding plate mounted in the case and configured to hold the hard disk drive; and
two resilient members, and each resilient member having a first end secured to the case and a second end secured to the holding plate;
wherein the holding plate is substantially parallel to the bottom plate, and a gap is defined between the holding plate and the bottom plate; each side plate defines a receiving portion, the holding plate comprises opposite two mounting portions extending out of the case through the receiving portions; and the holding plate is movable relative to the case to elastically deform the resilient members, allowing the hard disk drive to move relative to the case.

12. The mounting system of claim 11, wherein the second ends of the resilient members are secured to the mounting portions; and the case further comprises a blocking plate extending outwards from a top edge of each side plate and a blocking piece located on the blocking plate, and the first end of each resilient member is secured to the blocking piece.

13. The mounting system of claim 11, wherein each side plate defines a latching slot configured for a mounting post located on the hard disk drive moving along when the holding plate is moved.

14. The mounting system of claim 13, wherein the latching slot is substantially “W” shaped.

15. The mounting system of claim 13, wherein the latching slot comprises a slide-in slot, a slide-out slot, and a latching portion between the slide-in slot and the slide-out lot, the slide-in slot is configured for the mounting post to slide in, the slide-out slot is configured for the mounting post to slide out of the latching slot, and the latching portion is configured to block the mounting post in the latching slot.

16. The mounting system of claim 15, wherein the slide-in slot is substantially parallel to the slide-out slot, and the latching portion is substantially inverted “V” shaped.

17. The mounting system of claim 15, wherein the latching slot further comprises a first sliding slot extending slantingly from the slide-in slot and a second sliding slot extending slantingly from the slide-out slot, the slide-in slot is communicated with the slide-out slot via the latching portion, and the latching portion is above the first sliding slot and the second sliding slot.

18. The mounting system of claim 11, wherein the holding plate further comprises a plate body and a plurality of positioning posts extending from the plate body, the mounting portions extend from the plate body, and the positioning posts are configured to engage in a plurality of positioning holes defined in the hard disk drive.

19. An electronic device comprising:
a hard disk drive comprising two mounting posts; and
a mounting system comprising:
a case comprising a bottom plate and two side plates extending from the bottom plate;
a holding plate mounted in the case above the bottom plate and holds the hard disk drive thereon; and
two resilient members, each resilient member having a first end secured to the case and a second end secured to the holding plate;
wherein each side plate defines a latching slot, the holding plate is movable relative to the case to elastically deform the resilient members to move the hard disk drive, and the mounting posts are engaged in the latching slot and movable when the hard disk drive is moved relative to the case.

20. The electronic device of claim 19, wherein the latching slot is substantially “W” shaped and comprises a slide-in slot, a slide-out slot, and a latching portion between the slide-in slot and the slide-out lot, the mounting post is slid into the latching slot via the slide-in slot and is blocked in the latching slot by the latching portion and slid out of the latching slot via the slide-out slot.
